(19) United States
(12) Patent Application Publication
(10) Pub. No.: US 2017/0069255 A1
(43) Pub. Date: Mar. 9, 2017

(54) Virtual Touch Overlay On Touchscreen for Control of Secondary Display

(71) Applicant: Microvision, Inc., Redmond, WA (US)

(72) Inventors: Jari Honkanen, Monroe, WA (US); P. Selvan Viswanathan, Bellevue, WA (US)

(21) Appl. No.: 14/848,059

(22) Filed: Sep. 8, 2015

(51) Int. Cl. G09G 3/20; G09G 5/12; G09G 3/00; G06F 3/0488; G06F 3/0484; G06F 3/042; G06F 3/14

(52) U.S. Cl. CPC G09G 3/2096; G06F 3/042; G09G 5/12; G06F 3/1415; G06F 3/04883; G06F 3/04845; G09G 3/002; G09G 2370/06

(57) ABSTRACT

A device with a touchscreen includes a transparent virtual touch overlay used to modify content on a secondary display. The device may send display content to the secondary display either wired or wirelessly. The secondary display may be separate from the device or integrated in the device. The secondary display may use any display technology including a fixed installation monitor or a projector.

### FIELD

The present invention relates generally to display systems, and more specifically to display systems with touchscreens.

### BACKGROUND

Modern smartphones and tablet computers are typically designed to utilize a touchscreen/slate form factor, which have few, if any physical buttons. These modern devices instead rely upon touchscreens to present the user interface. The touchscreen is an electronic visual display that allows the user to view information and also control the device through single or multi-touch gestures by touching the screen with one or more fingers or with a special stylus or pen.

Many video hosts like smartphones and tablet computers can transmit (wired or wirelessly) media content to a secondary display. Typically, the secondary display is a fixed installation (wall or desk mounted TV/monitor) or a table/ceiling mounted projector.

### BRIEF DESCRIPTION OF THE DRAWINGS

FIG. 1 shows a mobile device with a virtual touch overlay and a projected secondary display in accordance with various embodiments of the present invention;

FIG. 2 shows a mobile device with a virtual touch overlay and a cabled secondary display in accordance with various embodiments of the present invention;

FIG. 3 shows a mobile device with a virtual touch overlay and a wireless secondary display in accordance with various embodiments of the present invention;

FIG. 4 shows a block diagram of a mobile device in accordance with various embodiments of the present invention;

FIG. 5 shows a scanning laser projector in accordance with various embodiments of the present invention;

FIGS. 6-11 show examples of gestures recognized by a virtual touch overlay used to modify images on a secondary display in accordance with various embodiments of the present invention; and

FIG. 12 shows a flow diagram of a method in accordance with various embodiments of the present invention.

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

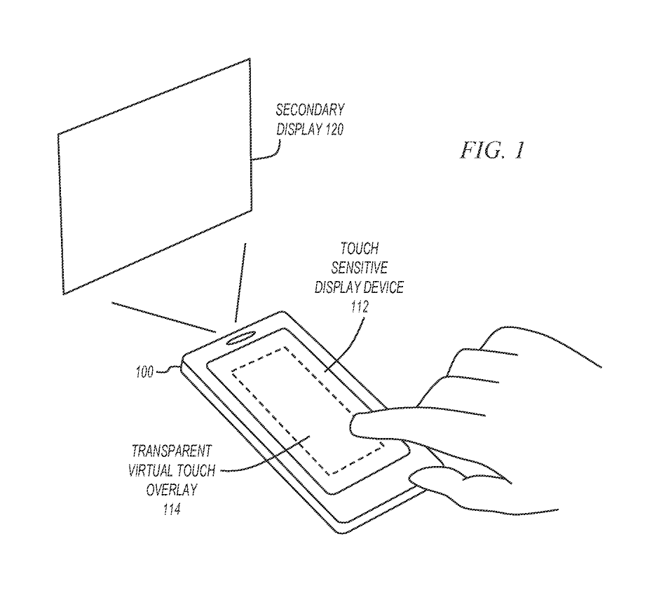

FIG. 1 shows a mobile device with a virtual touch overlay and a projected secondary display in accordance with various embodiments of the present invention. Mobile device 100 includes a touch sensitive display device 112 (also referred to herein as a “touchscreen”) capable of displaying content to a user. Typical content displayed on touch sensitive display device 112 may include images, video, contact information, phone call information, or the like. Touch sensitive display device 112 is also capable of displaying transparent virtual touch overlay 114.

Mobile device 100 also displays content on secondary display 120. In embodiments represented by FIG. 1, secondary display 120 is a projected image; however this is not a limitation of the present invention. Secondary display 120 may utilize any technology capable of displaying an image, additional examples of which are described more fully below. The visual content displayed on secondary display 120 may be the same or different than visual content displayed on touch sensitive display device 112. For example, touch sensitive display device 112 may display first content and secondary display may display second content where the first and second content may be the same or may be different.

In some embodiments, transparent virtual touch overlay 114 is a software application that may be started by the user when the user wants to interact with content displayed on secondary display 120 using touch sensitive display device 112. In operation, transparent virtual touch overlay 114 captures gestures made on the touchscreen and redirects them to control the secondary display. Two operational modes are described herein. Mobile device 100 is referred to as being in “normal mode” when transparent virtual touch overlay 114 is not active, and mobile device 100 is referred to herein as being in “overlay mode” when transparent touch overlay is active.

During operation in normal mode when transparent virtual touch overlay 114 is not active, the user interacts with content displayed on touch sensitive display device 112 by interacting with touch sensitive display device 112. In other words, gestures recognized by mobile device 100 are used to interact with the content displayed on touch sensitive display device 112 when transparent virtual touch overlay 114 is not active.

During operation in overlay mode when transparent virtual touch overlay 114 is active, the user interacts with content displayed on secondary display 120 by interacting with touch sensitive display device 112. In other words, gestures recognized by mobile device 100 are used to interact with the content displayed on secondary display 120 when transparent virtual touch overlay 114 is active.

In some embodiments, transparent virtual touch overlay 114 may be activated or deactivated with a specific gesture on the touchscreen, with a physical button on the device, or with a specific movement (such as a shake) of the device. Transparent virtual touch overlay 114 may be implemented and integrated into the device's operating system, or it can be implemented as a separate software application.

In some embodiments, when operating in overlay mode, touch sensitive display device 112 displays a visible, brightly colored border to indicate that transparent virtual touch overlay 114 is active. In other embodiments, touch sensitive display device 112 displays transparent virtual touch overlay 114 as a sheer off-white screen over the normal touchscreen content to clearly indicate to user the device is in overlay mode.

Mobile device 100 may be any type of device having a touch sensitive display device. For example, in some embodiments, mobile device 100 may be a smartphone or a tablet computer. Also for example, in other embodiments, mobile device 100 may be a laptop computer with a touchscreen, a desktop computer with a touchscreen, a television with a touchscreen, an accessory projector with a touchscreen, or the like. The various embodiments of the present invention are not limited by the type of mobile device having the touchscreen and virtual overlay.

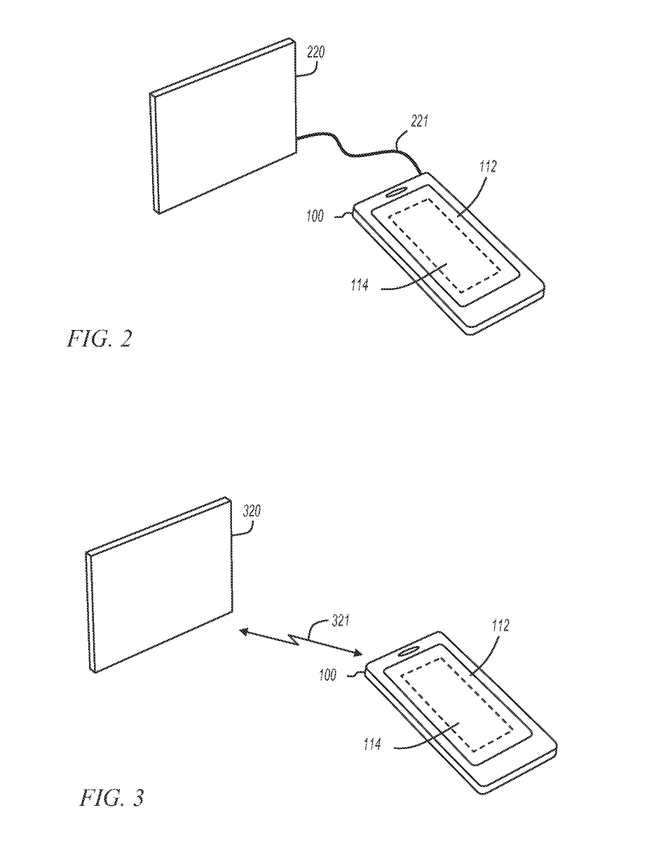

FIG. 2 shows a mobile device with a virtual touch overlay and a cabled secondary display in accordance with various embodiments of the present invention. In embodiments represented by FIG. 2, secondary display 220 is coupled to mobile device 100 by cable 221. Cable 221 may be any type of cable. For example, cable 221 may carry analog or digital signals, and may also carry control information. For example, cable 221 may provide a connection such as high definition multimedia interface (HDMI), mobile high definition link (MHL®), DisplayPort, SlimPort, or the like. In some embodiments, wired connections between mobile device 100 and secondary display 220 includes one or more control channels that allow mobile device 100 to transmit control commands to the secondary display 220.

Secondary display 220 may be any type of display device capable of displaying images or video from a mobile device over a cable. For example, secondary display 220 may be a computer monitor, a high definition television, an analog television, a projector, or the like. The various embodiments of the present invention are not limited by the type of secondary display.

FIG. 3 shows a mobile device with a virtual touch overlay and a wireless secondary display in accordance with various embodiments of the present invention. In embodiments represented by FIG. 3 secondary display 320 is coupled to mobile device 100 by wireless connection 321. Wireless connection 321 may be established with any type of radio at any frequency, and any protocol may be used to transmit data and control information. For example, wireless connection 321 may be established with a local area network (LAN) wireless radio, a personal area network (PAN) wireless radio, or any other type of radio. Also for example, protocols such as Miracast™ or Airplay may be used to transmit data and control information from mobile device 100 to secondary display 320. In some embodiments, wireless connections between mobile device 100 and secondary display 320 includes one or more control channels that allow mobile device 100 to transmit control commands to the secondary display 320.

Transparent virtual touch overlay operations as described herein are not restricted to a specific secondary display technology. For example, the secondary display may be a cathode ray tube (CRT), a scanning laser projector, digital light processing (DLP®) device, a liquid crystal on silicon (LCOS) device, a light emitting diode (LED) device, an organic LED (OLED) device, active matrix OLED (AMOLED) device, a holographic device, a front facing projector, a rear facing projector, or any other type of display device, including compound display systems like those in head-up display (HUD), augmented reality (AR), or virtual reality (VR) applications which have a display source like that listed above and a waveguide or optical medium including one or more passive or active optical/opto-electronic components. Further, mobile device 100 and the secondary display device may be the same type of device. For example, mobile device 100 and secondary device 320 may both be smartphones or may both be tablet computers.

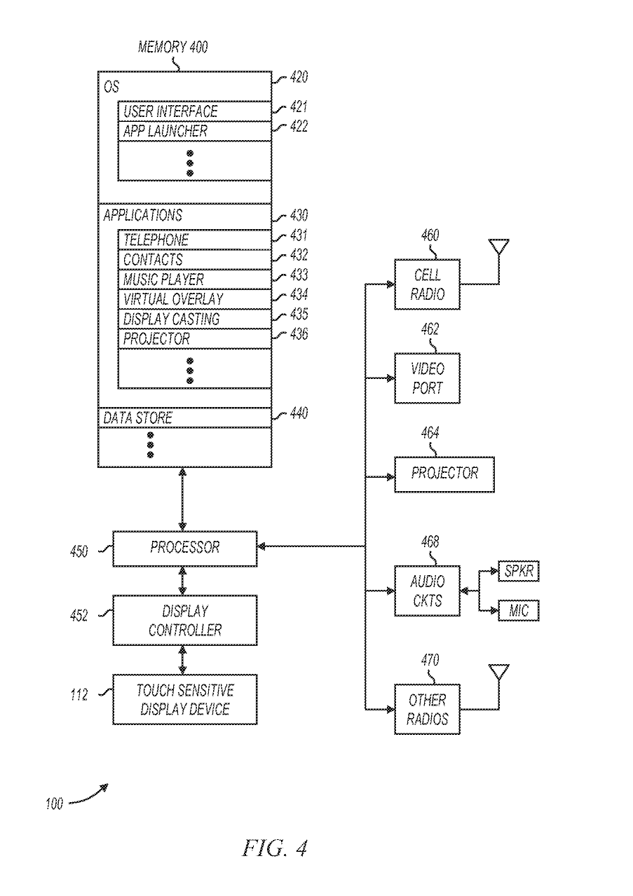

FIG. 4 shows a block diagram of a mobile device in accordance with various embodiments of the present invention. Mobile device 100 includes processor 450, memory 400, display controller 452, touch sensitive display device 112, cellular radio 460, video port 462, projector 464, audio circuits 468, and other radios 470. Mobile device 100 may be any type of mobile device that includes the components shown. For example, in some embodiments, mobile device 100 may be a mobile phone, a smartphone, a tablet computer, a laptop computer, or the like.

Processor 450 may be any type of processor capable of executing instructions stored in memory 400 and capable of interfacing with the various components shown in FIG. 4. For example, processor 450 may be a microprocessor, a digital signal processor, an application specific processor, or the like. In some embodiments, processor 450 is a component within a larger integrated circuit such as a system on chip (SOC) application specific integrated circuit (ASIC).

Display controller 452 provides an interface between processor 450 and touch sensitive display device 112. In some embodiments, display controller 452 is integrated within processor 450, and in other embodiments, display controller 452 is integrated within touch sensitive display device 112.

Touch sensitive display device 112 is a display device that includes a touch sensitive surface, sensor, or set of sensors that accept input from a user. For example, touch sensitive display device 112 may detect when and where an object touches the screen, and may also detect movement of an object across the screen. When touch sensitive display device detects input, display controller 452 and processor 450 (in association with user interface component 421 and virtual overlay component 434) determine whether a gesture is to be recognized and what to do with a gesture once it is recognized.

Touch sensitive display device 112 may be manufactured using any applicable display technologies, including for example, liquid crystal display (LCD), active matrix organic light emitting diode (AMOLED), and the like. Further, touch sensitive display device 112 may be manufactured using any application touch sensitive input technologies, including for example, capacitive and resistive touch screen technologies, as well as other proximity sensor technologies.

Cellular radio 460 may be any type of radio that can communicate within a cellular network. Examples include, but are not limited to, radios that communicate using orthogonal frequency division multiplexing (OFDM), code division multiple access (CDMA), time division multiple access (TDMA), and the like. Cellular radio 460 may operate at any frequency or combination of frequencies without departing from the scope of the present invention. In some embodiments, cellular radio 460 is omitted.

Video port 462 accepts and/or transmits video and/or audio signals. For example, video port 462 may be a digital port, such as a high definition multimedia interface (HDMI) interface that accepts a cable suitable to carry digital audio and video data. Further, video port 462 may include RCA jacks to accept or transmit composite inputs. Still further, video port 462 may include a VGA connector to accept or transmit analog video signals. In some embodiments, mobile device 100 may be tethered to a secondary display through video port 462, and mobile device 100 may transmit image and/or video content to the secondary display through video port 462. For example, referring back to FIG. 2, cable 221 may be coupled to video port 462. In some embodiments, video port 462 is omitted.

Projector 464 is an embedded projector capable of projecting display content. For example, referring back to FIG. 1, projector 464 may project content to create secondary display 120. In some embodiments, projector 464 is a scanning laser projector. In other embodiments, projector 464 is panel-based projector, such as a liquid crystal on silicon (LCOS) or digital light panel (DLP) based projector. In some embodiments, projector 464 is omitted.

Audio circuits 468 provide an interface between processor 450 and audio devices such as a speaker and microphone.

Other radios 470 may include any number or type of radio. For example, in some embodiments, other radios 470 includes a radio that operates at 2.4 GHz in the industrial, scientific, and medical (ISM) frequency band. In these embodiments, the 2.4 GHz radio may be used to wirelessly transmit display content to a secondary display. For example, referring back to FIG. 3, a 2.4 GHz radio within mobile device 100 may communicate wirelessly with secondary display 320 as shown at 321.

Mobile device 100 may include many other circuits and services that are not specifically shown in FIG. 4. For example, in some embodiments, mobile device 100 may include a global positioning system (GPS) radio, a Bluetooth radio, haptic feedback devices, and the like. Any number and/or type of circuits and services may be included within mobile device 100 without departing from the scope of the present invention.

Memory 400 may include any type of memory device. For example, memory 400 may include volatile memory such as static random access memory (SRAM), or nonvolatile memory such as FLASH memory. Memory 400 is encoded with (or has stored therein) one or more software modules (or sets of instructions), that when accessed by processor 450, result in processor 450 performing various functions. In some embodiments, the software modules stored in memory 400 may include an operating system (OS) 420 and applications 430. Applications 430 may include any number or type of applications. Examples provided in FIG. 4 include a telephone application 431, a contacts application 432, a music player application 433, a virtual overlay application 434, a display casting application 435, and a projector application. Memory 400 may also include any amount of space dedicated to data storage 440.

Operating system 420 may be a mobile device operating system such as an operating system to control a mobile phone, smartphone, tablet computer, laptop computer, or the like. As shown in FIG. 4, operating system 420 includes user interface component 421 and application launcher component 422. Operating system 420 may include many other components without departing from the scope of the present invention.

User interface component 421 includes processor instructions that cause mobile device 100 to display desktop screens, icons, and the like. User interface component 421 may also include processor instructions that cause mobile device 100 to recognize gestures, and to determine what to do with gestures once they are recognized. For example, when mobile device 100 is operating in normal mode, gestures recognized by mobile device 100 may be used to interact with content displayed on touch sensitive display device. Also for example, when mobile device 100 is operating in overlay mode, gestures recognized by mobile device 100 may be used to interact with content displayed on a secondary display or to alter the operation of the secondary display. User interface 421 also includes instructions to display menus, move icons, and manage other portions of the display environment.

Application launcher component 422 includes instructions that cause processor 450 to launch applications. For example, touch sensitive display device 112 may display icons for each of the applications 430. When a touch gesture is recognized by mobile device 100 when operating in normal mode and the touch gesture is at a display location of an application icon, application launcher component 422 may launch the application. For example, application launcher 422 may launch virtual overlay application 434, display casting application 435, or projector application 436 when an appropriate gesture is recognized.

Telephone application 431 may be an application that controls a cell phone radio. Contacts application 432 includes software that organizes contact information. Contacts application 432 may communicate with telephone application 431 to facilitate phone calls to contacts. Music player application 433 may be a software application that plays music files that are stored in data store 440.

Virtual overlay application 434 includes stored instructions that cause processor 450 to display transparent virtual touch overlay 114 (FIG. 1) on touch sensitive display device 112. When transparent virtual touch overlay is active, gestures made by a user on touch sensitive display device 112 are used to modify display content sent to a secondary display or to modify the display in some way. For example, when projector 464 is used for the secondary display, image or video data sent to projector 464 may be modified in response to detected gestures. In addition, control information (e.g., brightness, display size, aspect ratio, etc.) may be sent to projector 464 in response to detected gestures. Also for example, when video port 462 is cabled to a secondary display, image or video data sent to video port 462 may be modified in response to detected gestures. In addition, control information (e.g., brightness, display size, aspect ratio, etc.) may be sent to video port 462 in response to detected gestures.

Also for example, when a radio is used to wirelessly send data to a secondary display, image or video data sent to the radio may be modified in response to detected gestures. In addition, control information (e.g., brightness, display size, aspect ratio, etc.) may be sent wirelessly to the secondary display in response to detected gestures.

Display casting application 435 includes instructions that cause processor to communicate wirelessly with a secondary display. For example, display casting application 435 may communicate with a radio (e.g., one of the other radios 470) to send image, video, and control data to a secondary display. In some embodiments, display casting application 435 may receive control data from virtual overlay application 434 as a result of detected gestures.

Projector application 436 includes instructions that cause processor to communicate with projector 464. For example, projector application 436 may communicate with projector 464 to provide image, video, and control data. In some embodiments, projector application 436 may receive control data from virtual overlay application 434 as a result of detected gestures.

Each of the above-identified applications corresponds to a set of instructions for performing one or more functions described above. These applications (sets of instructions) need not be implemented as separate software programs, procedures or modules, and thus various subsets of these applications may be combined or otherwise re-arranged in various embodiments. For example, virtual overlay application 434 may be combined with user interface 421. Also for example, telephone application 431 may be combined with contacts application 432. Furthermore, memory 400 may store additional applications (e.g., video players, camera applications, etc.) and data structures not described above.

It should be noted that device 100 is presented as an example of a mobile device, and that device 100 may have more or fewer components than shown, may combine two or more components, or may have a different configuration or arrangement of components. For example, mobile device 100 may include many more components such as sensors (optical, touch, proximity etc.), or any other components suitable for use in a mobile device.

Memory 400 represents a computer-readable medium capable of storing instructions, that when accessed by processor 450, result in the processor performing as described herein. For example, when processor 450 accesses instructions within virtual overlay application 434, processor 450 recognizes gestures and determines whether the user intends to interact with content displayed on touch sensitive display device 112 or a secondary display.

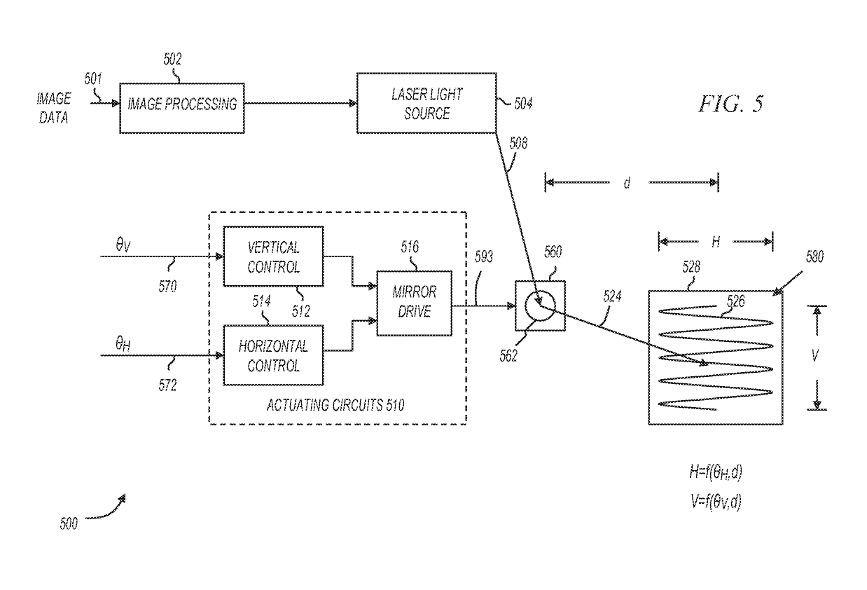

FIG. 5 shows a scanning laser projector in accordance with various embodiments of the present invention. In some embodiments, projector 500 is used to implement projector 464 (FIG. 4) in mobile device 100. In other embodiments, projector 500 is used as a secondary display that communicates with mobile device 100 either over a cable or wirelessly.

Projector 500 includes image processing component 502, visible laser light source 504, microelectromechanical system (MEMS) device 560 having scanning mirror 562, and actuating circuits 510. Actuating circuits 510 include vertical control component 512, horizontal control component 514, and mirror drive component 516.

In operation, image processing component 502 receives image data on node 501 and produces display pixel data to drive laser light source 504 when pixels are to be displayed. Laser light source 504 receives display pixel data and produces light having grayscale values in response thereto. Laser light source 504 may be monochrome or may include multiple different color light sources. For example, in some embodiments, laser light source 504 includes red, green, and blue light sources. In these embodiments, image processing component 502 outputs display pixel data corresponding to each of the red, green, and blue light sources.

The image data on node 501 represents image source data that is typically received with pixel data on a rectilinear grid, but this is not essential. For example, image data on node 501 may represent a grid of pixels at any resolution (e.g., 640×480, 848×480, 1920×1080). Scanning laser projector 500 includes a scanning mirror that scans a raster pattern. The raster pattern does not necessarily align with the rectilinear grid in the image source data, and image processing component 502 operates to produce display pixel data that will be displayed at appropriate points on the raster pattern. For example, in some embodiments, image processing component 502 interpolates vertically and/or horizontally between pixels in the source image data to determine display pixel values along the scan trajectory of the raster pattern.

Light source 504 may be laser light sources such as laser diodes or the like, capable of emitting a laser beam 508. The beam 508 impinges on a scanning mirror 562 to generate a controlled output beam 524. In some embodiments, optical elements are included in the light path between light source 504 and mirror 562. For example, scanning laser projector 500 may include collimating lenses, dichroic mirrors, or any other suitable optical elements.

Actuating circuits 510 provide one or more drive signal(s) 593 to control the angular motion of scanning mirror 562 to cause output beam 524 to generate a raster scan 526 on a projection surface 528. In operation, light source 504 produces light pulses and scanning mirror 562 reflects the light pulses as beam 524 traverses raster scan 526.

In some embodiments, raster scan 526 is formed by combining a sinusoidal component on the horizontal axis and a sawtooth component on the vertical axis. In these embodiments, controlled output beam 524 sweeps back and forth left-to-right in a sinusoidal pattern, and sweeps vertically (top-to-bottom) in a sawtooth pattern with the display blanked during flyback (bottom-to-top). FIG. 5 shows the sinusoidal pattern as the beam sweeps vertically top-to-bottom, but does not show the flyback from bottom-to-top. In other embodiments, the vertical sweep is controlled with a triangular wave such that there is no flyback. In still further embodiments, the vertical sweep is sinusoidal. The various embodiments of the present invention are not limited by the waveforms used to control the vertical and horizontal sweep or the resulting raster pattern.

MEMS device 560 is an example of a scanning mirror assembly that scans light in two dimensions. In some embodiments the scanning mirror assembly includes a single mirror that scans in two dimensions (e.g., on two axes). Alternatively, in some embodiments, MEMS device 560 may be an assembly that includes two scan mirrors: one that deflects the beam along one axis, and another that deflects the beam along a second axis largely perpendicular to the first axis.

The resultant display has a height (V) and a width (II) that are a function of the distance (d) from scanning mirror 562 to the projection surface, as well as the angular extents of mirror deflection. As used herein, the term “angular extents” refers to the total angle through which the mirror deflects rather than an instantaneous angular displacement of the mirror. The width (H) is a function of the distance (d) and the horizontal angular extents (θ_{H}). This relationship is shown in FIG. 5 as

H=f(θ_{H},d). (1)

The height (V) is a function of the distance (d) and the vertical angular extents (θ_{V}). This relationship is shown in FIG. 5 as

V=f(θ_{V},d). (2)

As shown in FIG. 5, horizontal control component 514 receives signal stimulus that represents the horizontal angular extents, and vertical control component 512 receives signal stimulus that represents the vertical angular extents. The angular extents signal stimulus may be provided on multiple signal lines (e.g., dedicated signal lines, or a shared bus) or may be provided on a single signal line (e.g., a serial bus). The manner in which signal stimulus is provided is not a limitation of the present invention.

Horizontal control component 514 and vertical control component 512 receive the angular extents signal stimulus and produce signals to effect actual mirror movement through the specified angles. The signals produced by vertical control component 512 and horizontal control component 514 are combined by mirror drive component 516, which drives MEMS device 560 with a composite signal on node 593. In some embodiments that include two scan mirrors, MEMS device 560 is driven directly by signals produced by vertical control component 512 and horizontal control component 514.

In various embodiments of the present invention, either or both of the vertical and horizontal angular extents of deflection are dynamically modified during operation of the scanning laser projector to accomplish various results. For example, vertical angular extents of deflection are controlled by the value θ_{V} provided to actuating circuits 510 on node 570, and horizontal angular extents of mirror deflection are controlled by the value θ_{H} provided to actuating circuits 510 on node 572. In some embodiments, the angular extents of mirror deflection are modified when a mobile device is operating in overlay mode, and a gesture is recognized. Example gestures that may result in changes to angular extents of mirror deflection are described further below.

Actuating circuits 510 are implemented using functional circuits such as phase lock loops (PLLs), filters, adders, multipliers, registers, processors, memory, and the like. Accordingly, actuating circuits 510 may be implemented in hardware, software, or in any combination. For example, in some embodiments, actuating circuits 510 are implemented in an application specific integrated circuit (ASIC). Further, in some embodiments, some of the faster data path control is performed in an ASIC and overall control is software programmable.

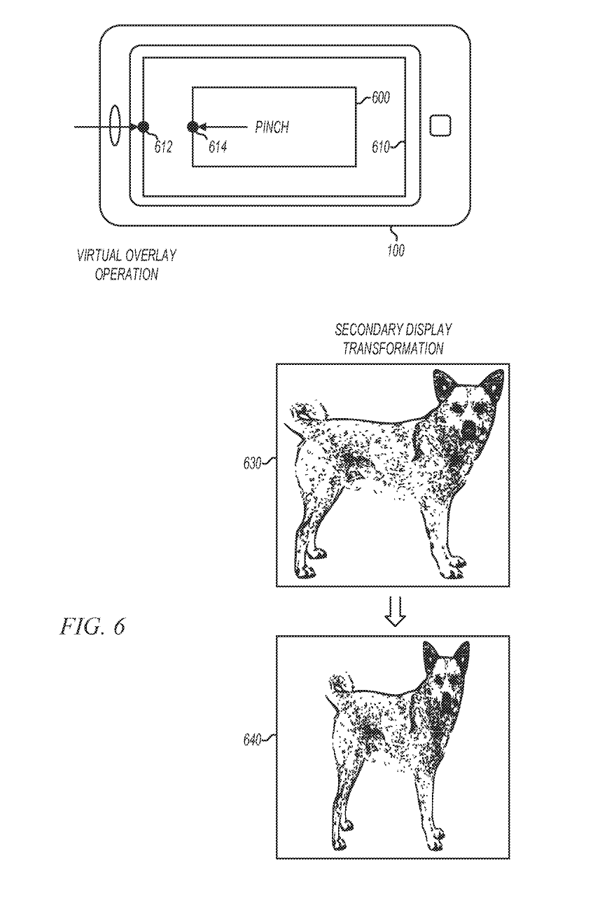

FIGS. 6-11 show examples of gestures recognized by a virtual touch overlay used to modify images on a secondary display in accordance with various embodiments of the present invention.

FIG. 6 depicts an example horizontal zoom operation. Mobile device 100 is shown with the overlay mode active. The transparent virtual overlay includes two rectangles. The inner rectangle 600 represents the minimum bounds for adjustment operation and the outer rectangle 610 represents the current display shape of the secondary display. In some embodiments, only one of rectangles 600 and 610 is visible. In other embodiments, the transparent virtual overlay displays graphical elements other than rectangles. For example, the transparent virtual overlay may include any polygon or freeform shape other than a rectangle at 610 to represent the current display shape of the secondary display.

In some embodiments, mobile device 100 includes one or more sensors (inertial position/orientation detection, cameras, depth sensors, acoustic sensors, etc.), that enable the system to detect the current display shape at startup or periodically during run-time and present the updated 610 as opposed to a default one at startup that may or may not reflect reality. This is very relevant especially when keystone or distortion correcting the secondary display.

The virtual overlay shown in FIG. 6 also includes two touch points 612 and 614. In some embodiments, the touch points are displayed on the screen, and in other embodiments, they are not. In the example of FIG. 6, a secondary display horizontal zoom may be accomplished using a multi-point pinch gesture on the touch sensitive display. The pinch gesture is accomplished by placing a first object (e.g., a first finger) at touch point 612 and placing a second object (e.g., a second finger) at touch point 614, and moving them together as shown by the arrows in FIG. 6. Although the touch points 612, 614 are shown vertically centered on the left side of the display, this is not a limitation of the present invention. For example, in some embodiments, the pinch gesture may be made on either side of the display, and need not be centered vertically.

In some embodiments, image data sent to a secondary display may be modified to zoom horizontally, or commands may be sent to the secondary display to effect the horizontal zoom. For example, if a display has a native zoom feature, then a zoom command may be send to the secondary display. Also for example, if the secondary display is a scanning laser projector such as projector 464 (FIG. 4), then information describing the horizontal angular extents of mirror deflection may be sent to the secondary display to effect a horizontal zoom.

Dual point horizontal pinch gesture on left or right side will decrease the secondary display width or horizontal angular extents accordingly. Dual point horizontal stretch gesture on left or right side will increase the secondary display width or horizontal angular extents accordingly. The display content of the secondary display prior to a horizontal zoom operation is shown at 630. The display content of the secondary display after a horizontal pinch gesture has been recognized is shown at 640.

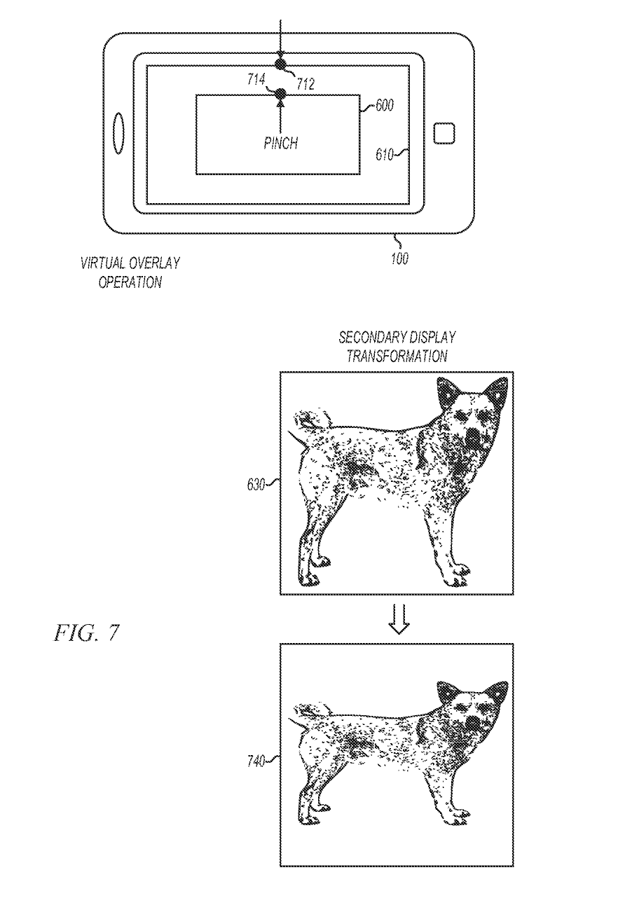

FIG. 7 depicts an example vertical zoom operation. Mobile device 100 is shown with the overlay mode active. The transparent virtual overlay includes two rectangles. The inner rectangle 600 represents the minimum bounds for adjustment operation and the outer rectangle 610 represents the current display shape of the secondary display. In some embodiments, only one of rectangles 600 and 610 is visible. In other embodiments, the transparent virtual overlay displays graphical elements other than rectangles.

The virtual overlay shown in FIG. 7 also includes two touch points 712 and 714. In some embodiments, the touch points are displayed on the screen, and in other embodiments, they are not. In the example of FIG. 7, a secondary display vertical zoom may be accomplished using a multi-point pinch gesture on the touch sensitive display. The pinch gesture is accomplished by placing a first object (e.g., a first finger) at touch point 712 and placing a second object (e.g., a second finger) at touch point 714, and moving them together as shown by the arrows in FIG. 7. Although the touch points 712, 714 are shown horizontally centered on the top of the display, this is not a limitation of the present invention. For example, in some embodiments, the pinch gesture may be made on either the top or bottom of the display, and need not be centered horizontally.

In some embodiments, image data sent to a secondary display may be modified to zoom vertically, or commands may be sent to the secondary display to effect the vertical zoom. For example, if a display has a native zoom feature, then a zoom command may be send to the secondary display. Also for example, if the secondary display is a scanning laser projector such as projector 464 (FIG. 4), then information describing the vertical angular extents of mirror deflection may be sent to the secondary display to effect a vertical zoom.

A dual point vertical pinch gesture on the top or bottom of the display will decrease the secondary display height or vertical angular extents accordingly. A dual point vertical stretch gesture on the top or bottom of the display will increase the secondary display height or vertical angular extents accordingly. The display content of the secondary display prior to a vertical zoom operation is shown at 630. The display content of the secondary display after a vertical pinch gesture has been recognized is shown at 740.

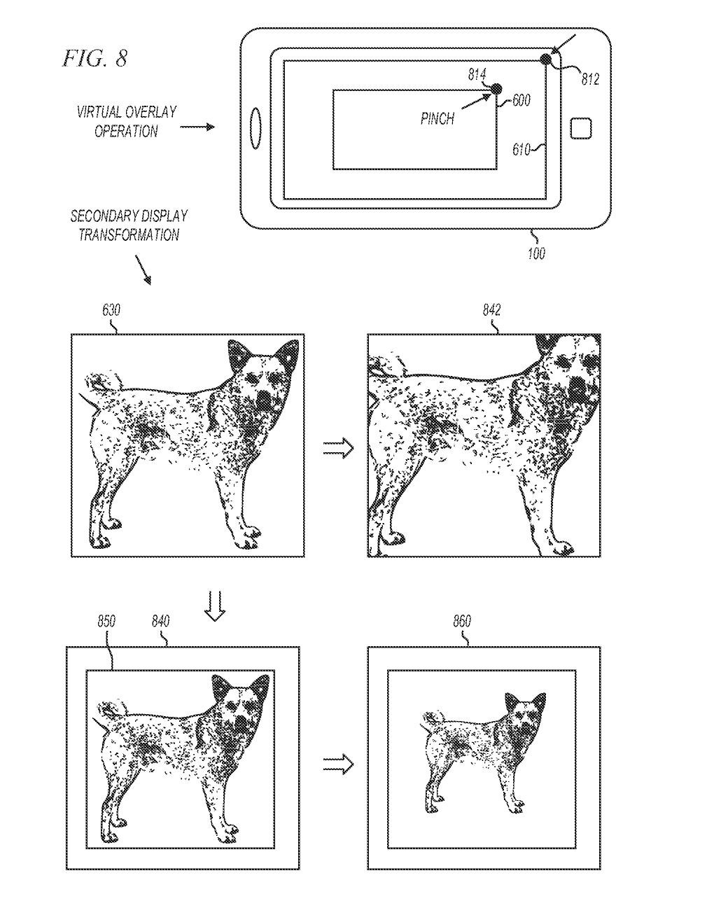

FIG. 8 depicts an example constant aspect ratio zoom operation. Mobile device 100 is shown with the overlay mode active. The transparent virtual overlay includes two rectangles. The inner rectangle 600 represents the minimum bounds for adjustment operation and the outer rectangle 610 represents the current display shape of the secondary display. In some embodiments, only one of rectangles 600 and 610 is visible. In other embodiments, the transparent virtual overlay displays graphical elements other than rectangles.

The virtual overlay shown in FIG. 8 also includes two touch points 812 and 814. In some embodiments, the touch points are displayed on the screen, and in other embodiments, they are not. In the example of FIG. 8, a secondary display constant aspect ratio zoom may be accomplished using a multi-point pinch gesture on the touch sensitive display. The pinch gesture is accomplished by placing a first object (e.g., a first finger) at touch point 812 and placing a second object (e.g., a second finger) at touch point 814, and moving them together as shown by the arrows in FIG. 8. Although the touch points 812, 814 are shown in one corner of the display, this is not a limitation of the present invention. For example, in some embodiments, the pinch gesture may be made on any of the four corners of the display.

In some embodiments, image data sent to a secondary display may be modified to perform a constant aspect ratio zoom, or commands may be sent to the secondary display to effect the constant aspect ratio zoom. For example, if a display has a native zoom feature, then a zoom command may be send to the secondary display. Also for example, if the secondary display is a scanning laser projector such as projector 464 (FIG. 4), then information describing the horizontal and vertical angular extents of mirror deflection may be sent to the secondary display to effect a constant aspect ratio zoom.

A dual point pinch gesture performed on an angle at any corner will decrease the secondary display size or the angular extents of mirror deflection accordingly. A dual point stretch gesture performed on an angle at any corner will increase the secondary display size or the angular extents of mirror deflection accordingly. The display content of the secondary display prior to a constant aspect ratio zoom operation is shown at 630. The display content of the secondary display after a pinch gesture has been recognized is shown at 840/860 and the display content of the secondary display after a stretch gesture has been recognized is shown at 842.

The transparent virtual overlay may include many different zoom modes. For example, consider the case where a scanning laser projector secondary display is initially set to display a 100% scan area (e.g., the vertical and horizontal angular extents of mirror deflection are set to 100% of the maximum possible vertical and horizontal angular extents). Now, if the mobile device is in overlay mode and a user performs a pinch gesture to zoom out: (1) the vertical and horizontal angular extents of mirror deflection may first be decreased to the minimum possible, (2) once the minimum mirror deflection is attained, the displayed image can be reduced further by modifying the image data being sent to the secondary display.

This is shown in FIG. 8 as the secondary display transitions from the image shown at 630 to the image shown at 840, and then to the image shown at 860. The bounding box 850 represents the scan area after the vertical and horizontal angular extents of mirror deflection have been reduced. The image at 860 represents a further reduction in image size through a reduction in image resolution.

When the zoom out operation is performed by decreasing mirror deflection, the full pixel resolution of the display image is maintained and image fidelity is not compromised by the zoom operation. When the mirror deflection reaches the minimum possible and then further image zooming occurs, this is a digital operation, where a multiple source pixels reduced into a single output pixel. This yields a fidelity reduced image zoom. If the initial display was already at the minimum mirror deflection, then zooming out directly yields the digitally zoomed image.

Also for example, consider the case where a scanning laser projector secondary display has its initial setting reduced to display a 50% scan area (e.g., the vertical and horizontal angular extents of mirror deflection are reduced such that only 50% of the maximum possible vertical and horizontal angular extents are utilized. Now, if the mobile device is in overlay mode and a user performs the pinch zoom expand gesture: (1) the vertical and horizontal angular extents of mirror deflection may first be increased up to the maximum possible, (2) once the maximum mirror deflection is attained, the displayed image can be expanded further by modifying the image data being sent to the secondary display.

When the zoom operation is performed by increasing mirror deflection, the full pixel resolution of the display image is maintained and image fidelity is not compromised by the zoom operation. When the mirror deflection reaches the maximum possible and then further image zooming occurs, this is a digital operation, where a single source pixel is expanded into multiple output pixels. This yields a fidelity reduced image zoom. If the initial display was already at the maximum mirror deflection, then zooming in directly yields the digitally zoomed image.

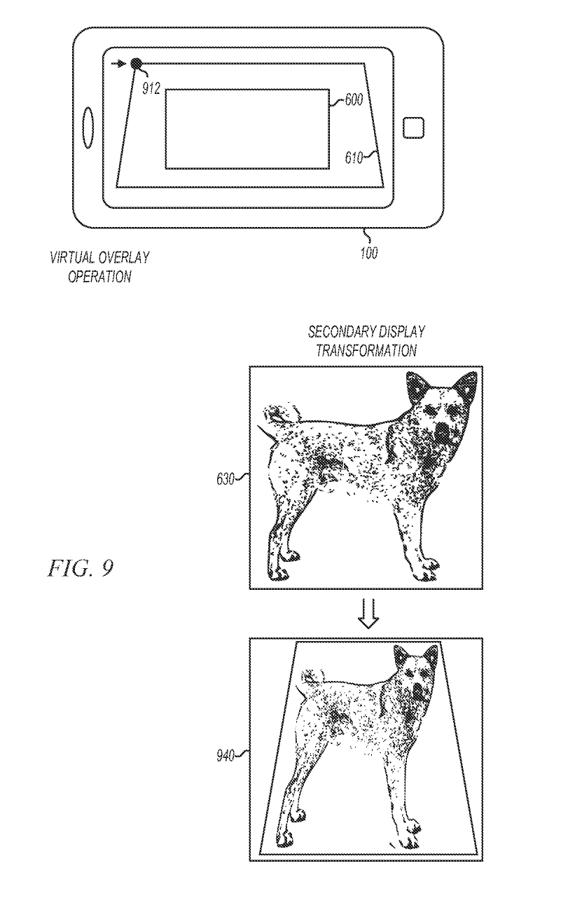

FIG. 9 depicts an example keystone distortion/correction operation. Mobile device 100 is shown with the overlay mode active. The transparent virtual overlay includes two rectangles. The inner rectangle 600 represents the minimum bounds for adjustment operation and the outer rectangle 610 represents the current display shape of the secondary display. In some embodiments, only one of rectangles 600 and 610 is visible. In other embodiments, the transparent virtual overlay displays graphical elements other than rectangles.

The virtual overlay shown in FIG. 9 also includes touch point 914. In some embodiments, touch point 912 is displayed on the screen, and in other embodiments, it is not. In the example of FIG. 9, a secondary display keystone operation may be accomplished using a single point gesture on the touch sensitive display. The gesture is accomplished by placing a first object (e.g., a first finger) at touch point 912 and moving the first object left, right, up, or down as shown by the arrow in FIG. 9. Although the touch point 912 is shown at the top left corner of the display, this is not a limitation of the present invention. For example, in some embodiments, the keystone gesture may be made on any corner of the display.

In some embodiments, image data sent to a secondary display may be modified to perform the keystoning, or commands may be sent to the secondary display to effect the keystoning. For example, if a display has a native keystone correction feature, then a command may be sent to the secondary display to accomplish the keystone correction. Also for example, if the secondary display is a scanning laser projector such as projector 464 (FIG. 4), then information describing the angular extents of mirror deflection may be sent to the secondary display to effect a keystoning operation.

The display content of the secondary display prior to a keystoning operation is shown at 630. The display content of the secondary display after a keystoning gesture has been recognized is shown at 940.

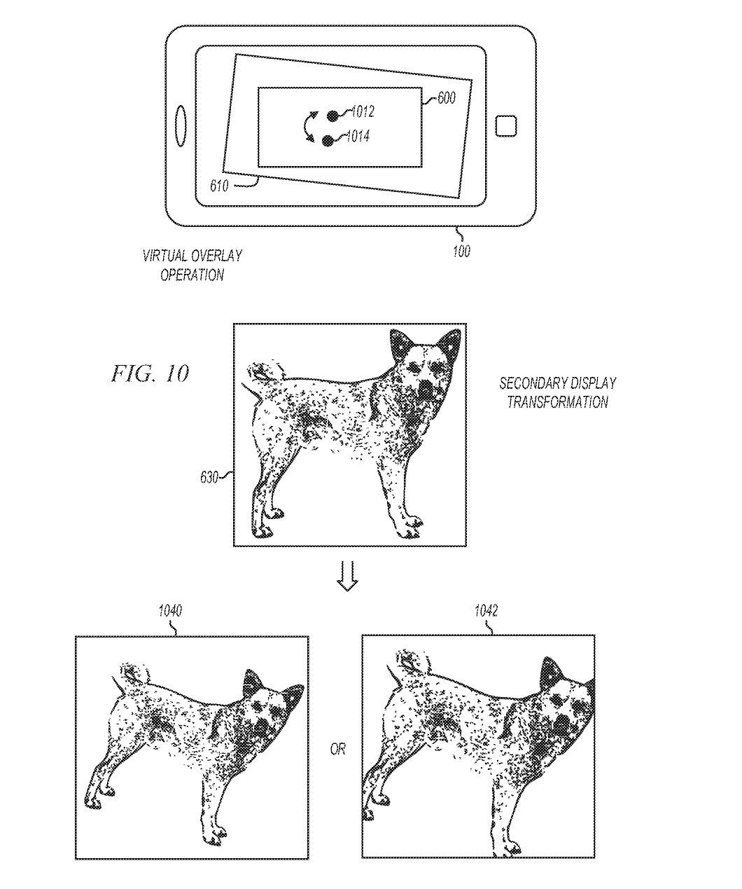

FIG. 10 depicts an example display rotation operation. Mobile device 100 is shown with the overlay mode active. The transparent virtual overlay includes two rectangles. The inner rectangle 600 represents the minimum bounds for adjustment operation and the outer rectangle 610 represents the current display shape of the secondary display. In some embodiments, only one of rectangles 600 and 610 is visible. In other embodiments, the transparent virtual overlay displays graphical elements other than rectangles.

The virtual overlay shown in FIG. 10 also includes two touch points 1012 and 1014. In some embodiments, the touch points are displayed on the screen, and in other embodiments, they are not. In the example of FIG. 10, a secondary display rotation operation may be accomplished using a multi-point rotation gesture on the touch sensitive display. The rotation gesture is accomplished by placing a first object (e.g., a first finger) at touch point 1012 and placing a second object (e.g., a second finger) at touch point 1014, and rotating them together as shown by the arrow in FIG. 10. Although the touch points 1012, 1014 are shown in the center of the display, this is not a limitation of the present invention. For example, in some embodiments, the rotation gesture may be made anywhere on the display.

In some embodiments, image data sent to a secondary display may be modified to perform a rotation operation, or commands may be sent to the secondary display to effect the rotation operation. For example, if a display has a native rotation feature, then a rotate command may be sent to the secondary display. Also for example, the image data being sent to the secondary display may be modified to effect the rotation.

A dual point rotation gesture performed on the display will rotate the image displayed on the secondary display. In some embodiments, the image size is modified as necessary to keep the displayed image to be cropped. The display content of the secondary display prior to a rotation operation is shown at 630. The display content of the secondary display after a rotation gesture has been recognized is shown at 1040 with a reduced image size so as to not crop the image, and the display content of the secondary display after a rotation gesture has been recognized is shown at 1042 with the image cropped.

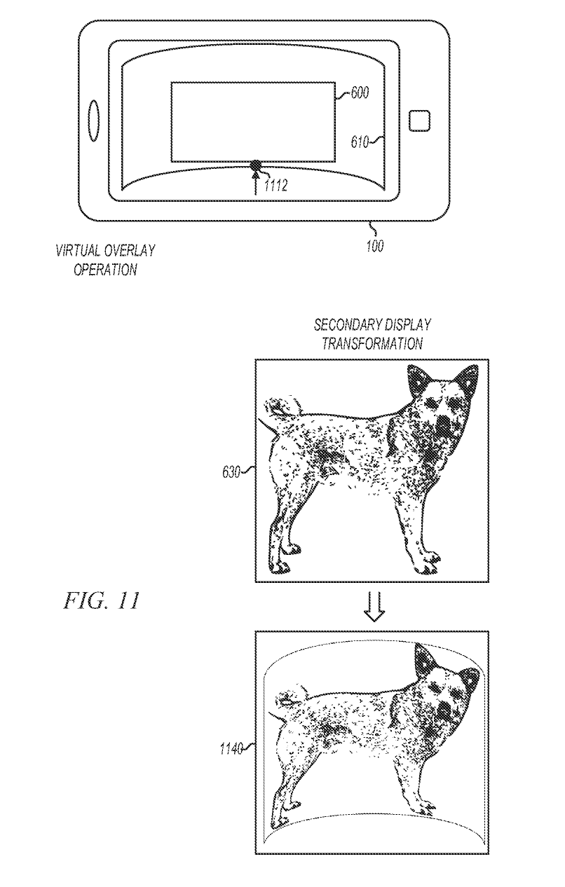

FIG. 11 depicts an example smile distortion/correction operation. Mobile device 100 is shown with the overlay mode active. The transparent virtual overlay includes two rectangles. The inner rectangle 600 represents the minimum bounds for adjustment operation and the outer rectangle 610 represents the current display shape of the secondary display. In some embodiments, only one of rectangles 600 and 610 is visible. In other embodiments, the transparent virtual overlay displays graphical elements other than rectangles.

The virtual overlay shown in FIG. 11 also includes touch point 1114. In some embodiments, touch point 1112 is displayed on the screen, and in other embodiments, it is not. In the example of FIG. 11, a secondary display smile distortion operation may be accomplished using a single point gesture on the touch sensitive display. The gesture is accomplished by placing a first object (e.g., a first finger) at touch point 1112 and moving the first object up or down as shown by the arrow in FIG. 11. Although the touch point 1112 is shown at the horizontally centered at the bottom of the display, this is not a limitation of the present invention. For example, in some embodiments, the smile distortion gesture may be made on any side of the display, and is not necessarily centered.

In some embodiments, image data sent to a secondary display may be modified to perform the smile distortion, or commands may be sent to the secondary display to effect the smile distortion. For example, if a display has a native smile distortion correction feature, then a command may be sent to the secondary display to accomplish the smile distortion correction. Also for example, the image data being sent to the secondary display may be modified to effect the smile distortion correction.

The display content of the secondary display prior to a smile distortion operation is shown at 630. The display content of the secondary display after a smile distortion gesture has been recognized is shown at 1140.

Any combination of the above described gestures may be combined to apply the described transformations to the secondary display. Although FIGS. 6-11 show transparent virtual overlays that display graphical elements such as rectangles and touch points, in some embodiments, the transparent virtual overlay displays no graphical elements. Further, gestures need not include absolute motion from defined touchpoints in order to transform the secondary display. For example, in some embodiments, relative motion at or near the touchpoint locations is adequate to register a gesture and to apply a corresponding secondary display transformation.

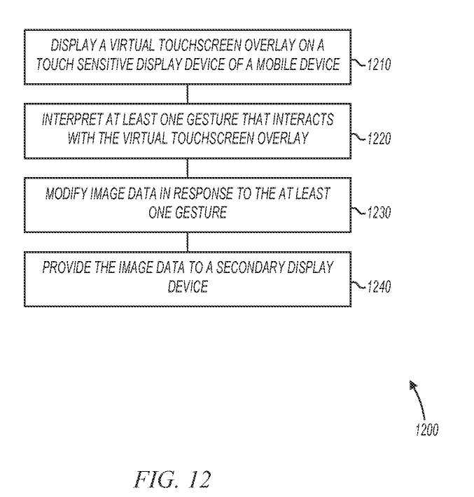

FIG. 12 shows a flow diagram of methods in accordance with various embodiments of the present invention. In some embodiments, method 1200, or portions thereof, is performed by a mobile device, embodiments of which are shown in previous figures. Further, in some embodiments, method 1200, or portions thereof, is performed by a processor executing instructions, embodiments of which are shown in previous figures. In other embodiments, method 1200 is performed by a series of circuits or an electronic system. Method 1200 is not limited by the particular type of apparatus performing the method. The various actions in method 1200 may be performed in the order presented, or may be performed in a different order. Further, in some embodiments, some actions listed in FIG. 12 are omitted from method 1200.

Method 1200 is shown beginning with block 1210. As shown at 1210, a virtual touchscreen overlay is displayed on a touch sensitive display device. This corresponds to transparent virtual touchscreen overlay 114 being displayed on touch sensitive display device 112. In some embodiments, the virtual touchscreen overlay is displayed when an application (e.g., virtual overlay application 434) is run by a processor, or when an already running application is activated, thereby putting the mobile device into an overlay mode.

In some embodiments, the virtual touchscreen overlay includes graphical elements such as rectangles, touch points, or the like. For example, the virtual touchscreen may include a rectangle, polygon, or freeform shape that represents the current display shape of the secondary display.

At 1220, at least one gesture that interacts with the virtual touchscreen overlay is interpreted. Example gestures that interact with the virtual touchscreen overlay are shown in, and described with reference to, the previous figures. Example gestures include single-touch gestures, multi-touch gestures, zoom gestures, distortion correction gestures, rotation gestures, and the like.

At 1230, image data is modified in response to the at least one gesture. For example, an image may be digitally zoomed, rotated, or distorted in response to a gesture that interacts with a virtual touchscreen overlay. At 1230, the image data is sent to the secondary display. The secondary display may be embedded in the mobile device, or may be connected with a cable or wirelessly. In some embodiments, control information is sent to the secondary information in response to gestures. For example, a native zoom operation or distortion correction operation may be performed, or angular extents of mirror deflection of a scanning mirror may be modified in response to a gesture.

Although the present invention has been described in conjunction with certain embodiments, it is to be understood that modifications and variations may be resorted to without departing from the scope of the invention as those skilled in the art readily understand. Such modifications and variations are considered to be within the scope of the invention and the appended claims.

What is claimed is:

1. A mobile device comprising:
a touch sensitive display device;
an interface to provide image data to a secondary display;
a processor; and
a nontransitory computer readable medium having instructions stored thereon that when executed by the processor provide a virtual touchscreen overlay displayed on the touch sensitive display device to modify the image data provided to the secondary display.

2. The mobile device of claim 1 wherein the interface to provide image data to a second display comprises a cabled interface.

3. The mobile device of claim 1 wherein the interface to provide image data to a second display comprises a radio.

4. The mobile device of claim 1 wherein the secondary display comprises an embedded projector.

5. The mobile device of claim 4 wherein the embedded projector comprises a scanning laser projector.

6. The mobile device of claim 5 wherein the virtual touchscreen overlay modifies angular extents of mirror deflection of a scanning mirror within the scanning laser projector.

7. The mobile device of claim 1 wherein the mobile device comprises a mobile phone.

8. The mobile device of claim 1 wherein the mobile device comprises a tablet computer.

9. An apparatus comprising:
a touch sensitive display device to display first content;
a scanning laser projector to display second content; and
an application that provides an overlay over the first content displayed on the touch sensitive display device, wherein the application modifies the second content displayed by the scanning laser projector in response to touch gestures made by a user.

10. The apparatus of claim 9 further comprising modifying angular extents of mirror deflection within the scanning laser projector in response to the touch gestures.

11. The apparatus of claim 9 wherein the apparatus comprises a mobile phone.

12. The apparatus of claim 9 wherein the apparatus comprises a tablet computer.

13. A method comprising:
displaying a virtual touchscreen overlay on a touch sensitive display device of a mobile device;
interpreting at least one gesture that interacts with the virtual touchscreen overlay;
modifying image data in response to the at least one gesture; and
providing the image data to a secondary display device.

14. The method of claim 13 wherein displaying the virtual touchscreen is in response to a user starting an application on the mobile device.

15. The method of claim 13 wherein modifying image data comprises zooming.

16. The method of claim 13 wherein modifying image data comprises keystoning.

17. The method of claim 13 wherein modifying image data comprises correction for smile distortion.

18. The method of claim 13 further comprising modifying angular extents of a scanning mirror in a scanning laser projector in response to the at least one gesture.

19. The method of claim 13 wherein providing the image data to a secondary display device comprises transmitting the image data using a radio.

20. The method of claim 13 wherein providing the image data to a secondary display device comprises transmitting the image data over a wired interface.

21. The method of claim 13 wherein displaying a virtual touchscreen overlay on a touch sensitive display device of a mobile device comprises displaying a graphical element to show a current display shape of content displayed on the secondary display device.

22. The method of claim 21 wherein the graphical element comprises a rectangle.

23. The method of claim 21 wherein the graphical element comprises a freeform shape.
